(19) United States
(12) Patent Application Publication
(10) Pub. No.: US 2011/0246189 A1
(43) Pub. Date: Oct. 6, 2011

(54) DICTATION CLIENT FEEDBACK TO FACILITATE AUDIO QUALITY

(75) Inventors: Peter Fox, Boulder, CO (US); Michael Clark, Longmont, CO (US); Jarek Foltynski, Boulder, CO (US)

(73) Assignee: nVoq Incorporated, Boulder, CO (US)

(21) Appl. No.: 13/053,005

(22) Filed: Mar. 21, 2011

Related U.S. Application Data
(60) Provisional application No. 61/319,078, filed on Mar. 30, 2010.

(51) Int. Cl. G10L 21/02; G10L 11/06

(52) U.S. Cl. 704/210; 704/226; 704/E21.002; 704/E11.007

(57) ABSTRACT

An audio quality feedback system and method is provided. The system receives audio from a client via a communication device such as a microphone, The audio quality feedback system compares the received audio to one or more parameters regarding the quality of the feedback. The parameters include, for example, clipping, periods of silence, signal to noise ratios. Based on the comparison, feedback is generated to allow adjustment of the communication device or use of the communication device to improve the quality of the audio.

### CLAIM OF PRIORITY UNDER 35 C. §§119 AND 120

The present application claims the benefit of U.S. Provisional Patent Application Ser. No. 61/319,078, titled, DICTATION CLIENT FEEDBACK TO FACILITATE AUDIO QUALITY, filed Mar. 30, 2010, incorporated herein by reference as if set out in full.

### REFERENCE TO OTHER CO-PENDING APPLICATIONS FOR PATENT

None.

### BACKGROUND

1. Field

The technology of the present application relates generally to dictation systems, and more particular, to providing feedback to a dictation user regarding the quality of dictated audio to allow correction while dictation is on-going.

2. Background

Originally, dictation was an exercise where one person spoke while another person transcribed what was spoken. The transcriptionist would hear and write what was dictated. With modern technology, dictation has advanced to the stage where voice recognition and speech to text technologies allow computers and processors to serve as the transcriptionist.

Current technology has resulted in essentially two styles of computer based dictation and transcription. One style involves loading software on a machine to receive and transcribe the dictation, which is generally known as client side dictation. The machine transcribes the dictation in real-time or near real-time. The other style involves saving the dictation audio file and sending the dictation audio file to a centralized server, which is generally known as server side batch dictation. The centralized server transcribes the audio file and returns the transcription. Often the transcription is accomplished after hours, or the like, when the server has less processing demands.

In either case, client side dictation or server side batch dictation, audio must be captured by the system. The audio file is provided to a speech to text engine that transcribes the audio file into a textual data file. The quality of the textual data file (i.e., the accuracy of transcribing the audio file) depends in part on the quality of the audio signal received by the system and either streamed or uploaded to the transcription engine.

Currently, however, existing dictation and transcription systems do not provide any feedback to a dictation client regarding the quality of the audio file other than providing a poorly transcribed audio file. In some cases, however, the poor quality of the transcription is due to the audio file capturing saturated sound, clipped sound, garbled sound, or the like. Thus, it would be desirous to provide information (in other words feedback) to the dictation client regarding the quality of the audio file. Thus, against this background, it is desirable to develop a dictation client feedback to improve audio file quality.

### SUMMARY

Aspects of the technology of the present invention provide a remote client station that simply requires the ability to transmit audio files via a streaming connection to the dictation manager or the dictation server. The dictation server can return the transcription results via the dictation manager or via a direct connection depending on the configuration of the system.

In certain embodiments, an apparatus is provided that includes a dictation manager coupled to a first network that receives an audio file from a client station. The dictation manager is configured to transmit the audio file received from the client station to a dictation server that transcribes the audio file to a textual file. A memory associated with the manager is configured to store the audio file as required. The audio quality manager fetches the audio from the memory and compares the audio signal to at least one parameter relating to signal quality. Based on the comparison, the audio quality manager transmits configuration adjustments that, once implemented, function to improve the quality of the transcription.

In other embodiments, a method of evaluating the quality of an audio file received for dictation from a client station is performed on at least one processor. The method comprises receiving an audio file from a client station and comparing the audio file received from the client station to at least one predetermined parameter regarding the quality of the audio file. Based on the comparison, information on how to improve the quality of the audio received is transmitted.

In still other embodiments, a system is provided. The system includes a client station that has a communication device, such as, for example, a microphone. The client station is coupled to a dictation manager that is configured to receive the audio from the client station and transmit the audio to a dictation server. The audio may be streamed or batched. The dictation server includes a speech to text engine that converts the audio to a textual file. An audio quality manager is coupled to the dictation manager; and at least one memory that contains parameter data usable to determine the quality of the audio received by the dictation manager.

In certain aspects of the technology, the parameter data relates to at least one of silence preceding or trailing utterances to ensure the speech to text engine is receiving the complete utterance. Failure to provide sufficient silence may result in the utterance being truncated.

In other aspects of the technology, the parameter data relates to at least one of clipping. Clipping relates to the volume or amplitude of the audio signal being such that the amplifier(s) are saturated which distorts the audio.

In still other aspects of the technology, the parameter data relates to signal to noise ratios. The lower the signal to noise ratio (i.e., the more background noise) the more likely the audio will be converted incorrectly.

These and other aspects of the present system and method will be apparent after consideration of the Detailed Description and Figures herein. It is to be understood, however, that the scope of the invention shall be determined by the claims as issued and not by whether given subject matter addresses any or all issues noted in the Background or includes any features or aspects recited in this Summary.

### BRIEF DESCRIPTION OF THE DRAWINGS

FIG. 1 is a functional block diagram of an exemplary system consistent with the technology of the present application;

FIG. 2 is a functional block diagram of an exemplary system consistent with the technology of the present application;

FIG. 3 is a functional block diagram illustrative of a methodology consistent with the technology of the present application;

FIG. 4 is a functional block diagram of an exemplary graphical user interface consistent with the technology of the present application; and

FIG. 5 is an exemplary waveform.

### DETAILED DESCRIPTION

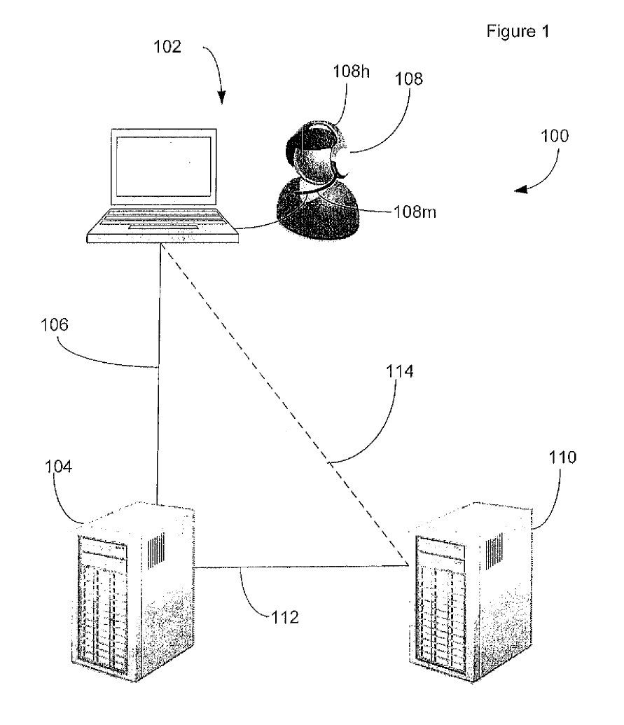

The technology of the present application will now be explained with reference to FIGS. 1-5. While the technology of the present application is described with relation to a remote dictation server connected to the dictation client via a network or internet connection to provide streaming audio over the internet connection using conventional streaming protocols, one of ordinary skill in the art will recognize on reading the disclosure that other configurations are possible. For example, the technology of the present application is described with regard to a thin client station but more processor intensive options could be deployed in a thick or fat client. Moreover, the technology of the present application is described with regard to certain exemplary embodiments. The word “exemplary” is used herein to mean “serving as an example, instance, or illustration.” Any embodiment described herein as “exemplary” is not necessarily to be construed as preferred or advantageous over other embodiments. All embodiments described herein should be considered exemplary unless otherwise stated.

Referring first to FIG. 1, a distributed dictation system 100 is provided.

Distributed dictation system 100 may provide transcription of dictation in real-time or near real-time allowing for delays associated with transmission time, processing, and the like. Of course, delay could be built into the system to allow, for example, a user the ability to select either real-time or batch transcription services. For example, to allow batch transcription services, system 100 may cache audio files at a client device, a server, a transcription engine or the like to allow for later transcription of the audio file to text that may be returned to the client station or retrieved by the client at a later time.

As shown in distributed dictation system 100, one or more client stations 102 are connected to a dictation manager 104 by a first network connection 106. First network connection 106 can be any number of protocols to allow transmission of audio information using a standard Internet protocol. Client station 102 would receive audio (i.e., dictation) from a user via client communication device 108, which are shown in the present example as a headset 108h and a microphone 108m, or the like. Microphone 108m functions as a conventional microphone and provides audio signals to client station 102. The audio may be saved in a memory associated with client station 102 or streamed over first network connection 106 directly to the dictation manager 104. As mentioned above, in a thick or fat client station 102, dictation manager 104 may be incorporated into client station 102 as a matter of design choice. If the audio is saved at the client station 102, the audio may be batch uploaded to dictation manager 104.

While shown as a separate part, microphone 108m may be integrated into client station 102, such as, for example, if client station 102 is a cellular phone, personal digital assistant, smart phone, or the like. If microphone 108m is separate as shown, microphone 108m is connected to client station 102 using a conventional connection such as a serial port, a specialized peripheral device connection, a data port, or a universal serial bus, a Bluetooth connection, a WiFi connection, or the like. Also, while shown as a monitor or computer station, client station 102 may be a wireless device, such as a WIFI-enabled computer, a cellular telephone, a PDA, a smart phone, or the like. Client station 102 also may be a wired device, such as a laptop or desktop computer, using conventional Internet protocols to transmit audio.

Dictation manager 104 may be connected to one or more dictation servers 110 by a second network connection 112. Second network connection 112 may be the same or different than first network connection. Second network connection also may be any of a number of conventional wireless or wired connection protocols. Dictation manager 104 and dictation server 110 may be a single integrated unit connected via a PCI bus or other conventional bus. Moreover, for a fat client as explained above, dictation server 110 may be incorporated into client station 102 along with dictation manager 104. However, for fat client stations 102, the dictation server 110 serves only the single client station, thus obviating the need for a dictation manager 104. Each dictation server 110 incorporates or accesses a speech transcription engine as is generally known in the art. Operation of the speech transcription engine will not be further explained herein except as necessary in conjunction with the technology of the present application as speech recognition and speech transcription engines are generally understood in the art. For any given dictation, dictation manager 104 would direct the audio file from client station 102 to an appropriate dictation server 110 that would transcribe the audio and return transcription results, i.e., the text of the audio. The connection between client station 102 and dictation server 110 may be maintained via dictation manager 104. Alternatively, as shown in phantom, a connection 114 may be established directly between client station 102 and dictation server 110. Additionally, dictation manager 104 may manage a number of simultaneous connections so several client stations 102 and dictation servers 110 can be managed by dictation manager 104, although only one is currently shown for simplicity. Dictation manager 104 also provides the added benefit of facilitating access between multiple client stations and multiple dictation servers over, for example, using a conventional call center where management and administration of changing clients is difficult to accomplish.

Network connections 106 and 112 may be any conventional network connections capable of providing streaming audio from client station 102 to dictation manager 104 and from dictation manager 104 to the dictation server 110. Moreover, dictation manager 104 may manage the transmission of data in both directions. From the client station 102, dictation manager 104 receives the audio stream and directs the audio stream to a dictation server 110. The dictation server 110 transcribes the audio to text and transmits the text to dictation manager 104 and dictation manager 104 directs the text back to client station 102 to display on a monitor or other output device associated with client station 102. For fat clients, network connections 106 and 112 may be any conventional bus connection, such as, for example, a PCI bus protocol, or the like.

Of course, similar to caching the audio for later transcription, the text may be stored for later retrieval by the user of client station 102. Storing the text for later retrieval may be beneficial for situations where the text cannot be reviewed due to conditions, such as driving a car, or the client station does not have a sufficient display to name but two situations. Network connections 106 and 112 allow streaming data from dictation server 110 though dictation manager 104 to client station 102. Dictation manager 104 may manage the data as well. Client station 102 would use the data from dictation server 110 to populate a display on client station 102, such as, for example, a text document that may be a word document.

As mentioned, one drawback to any automated dictation system is the quality of the transcription related to the quality of the audio input into the system. Audio input quality may be influenced by many factors. For example, speaking in a loud voice may saturate the signal by overloading the amplifiers in the system, mishandling of the on/off device may result in truncated speech as the start or end of words, clauses, or phrases may not be recorded as the user started speaking before or continued speaking after the system was capable of receiving input (sometime referred to as when the system is listening).

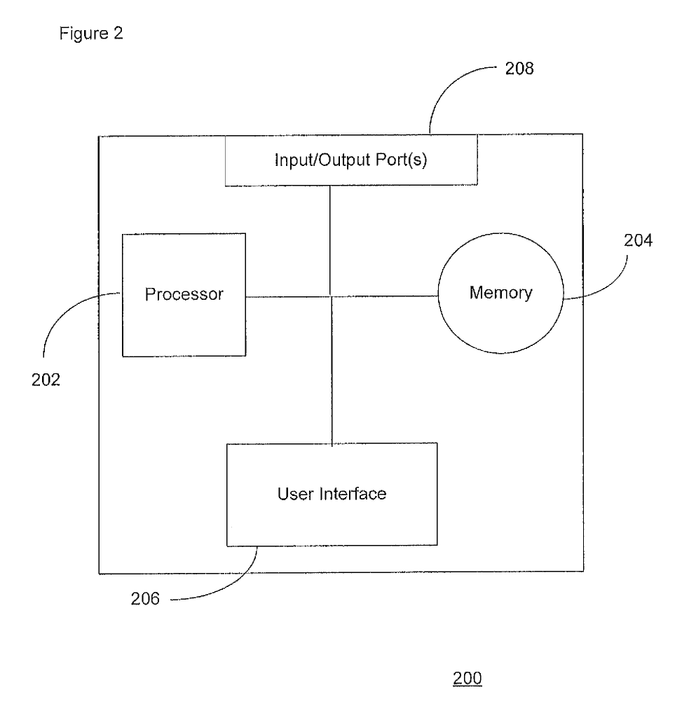

Referring now to FIG. 2, an audio quality manager 200 is provided.

Audio quality manager may be a separate module, integrated in one or more of the client station 102, dictation manager 104, or dictation server 110, or a combination thereof. Audio quality manager 200 includes a processor 202, such as a microprocessor, chipset, field programmable gate array logic, or the like, that controls the major functions of the audio quality manager 200, such as for example, measuring and monitoring the saturation of audio signals, whether audio signals are clipped, the signal to noise ratio, and the like, as will be explained in further detail below. Processor 202 also processes various inputs and/or data that may be required to operate the audio quality manager 200. Audio quality manager 200 also includes a memory 204 that is interconnected with processor 202. Memory 204 may be remotely located or co-located with processor 202. The memory 204 stores processing instructions to be executed by processor 202. The memory 204 also may store data necessary or convenient for operation of the dictation system. For example, memory 204 may store historical information regarding, for example, signal to noise ratios to determine changes in the same. Memory 204 may be any conventional media and include either or both volatile or nonvolatile memory. Audio quality manager 200, optionally, may be preprogrammed so as not to require a user interface 206, but audio quality manager 200 may include a user interface 206 that is interconnected with processor 202. Such user interface 206 could include speakers, microphones, visual display screens, physical input devices such as a keyboard, mouse or touch screen, track wheels, cams or special input buttons to allow a user to interact with audio quality manager 200. Audio quality manager further would include input and output port(s) 208 to receive audio files and transmit information as needed or desired. Audio quality manager 200 would receive audio files to be or already transmitted to the dictation servers 110 for transcription.

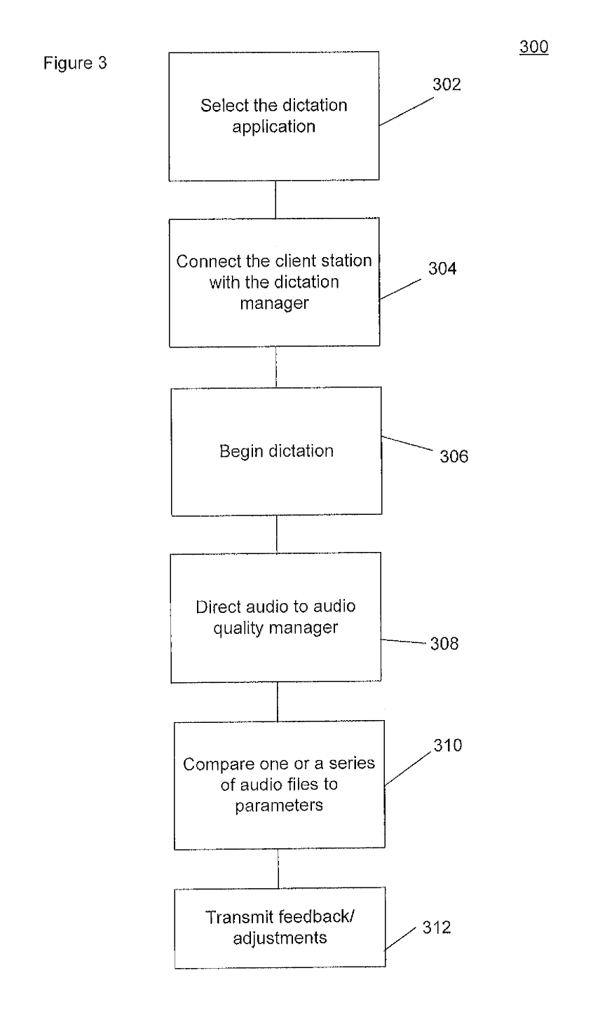

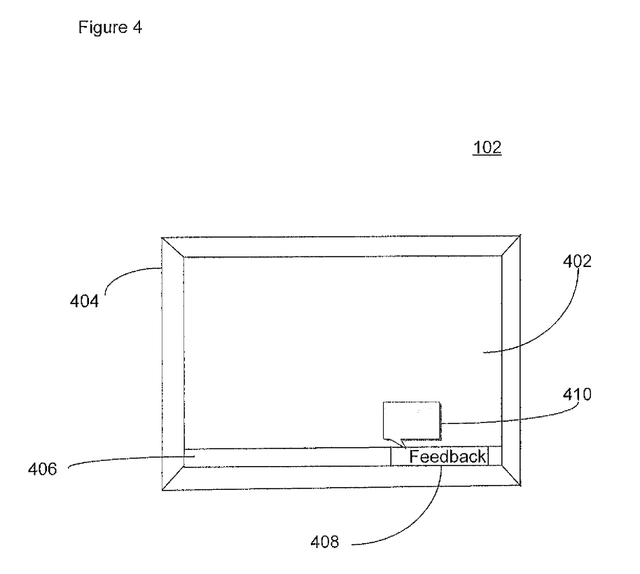

Referring now to FIG. 3, a flow chart 300 is provided illustrative of a methodology of using the technology of the present application. While described in a series of discrete steps, one of ordinary skill in the art would recognize on reading the disclosure that the steps provided may be performed in the described order as discrete steps, a series of continuous steps, substantially simultaneously, simultaneously, in a different order, or the like. Moreover, other, more, less, or different steps may be performed to use the technology of the present application. In the exemplary methodology, however, a user at client station 102 would first select a dictation application from a display on client station 102, step 302. The selection of an application that has been enabled for dictation that can be either a client or web based application. The application may be selected using a conventional process, such as, for example, double clicking on an icon, selecting the application from a menu, using a voice command, or the like. Alternatively to selecting the application from a menu on a display, client station 102 may connect to the server running the application by inputting an Internet address, such as a URL, or calling a number using conventional call techniques, such as, for example PSTN, VoIP, a cellular connection or the like. The application, as explained above, may be web enabled, loaded on the client station, or a combination thereof. Client station 102 would establish a connection to dictation manager 104 using a first network connection 106, step 304. Sequentially or substantially simultaneously, the user may begin dictating using the client communication device 108, step 306. The audio would be directed to audio quality manager 200, either streamed or uploaded, step 308. Audio quality manager 200 would analyze the audio for quality using a number of different parameters, step 310, some examples of which will be provided in more detail below. Audio quality manager 200 would transmit adjustment suggestions to client station 102 based on comparing one or a series of audio files to the different parameters, step 312. Alternatively, audio quality manager 200 may transmit adjustment suggestions to a supervisor (not specifically shown) instead of the actual client station 102 so as not to disrupt operations at the client station. In other aspects of the invention, audio quality manager may provide the information to an offline repository, generate reports, or the like. In still other aspects, the audio quality information may be provided to supervisors, administrators, group leaders, users, etc. for later review. Referring to FIG. 4, a portion of a graphical display 402 is provided on a display 404 of client station 102, in this example. Graphic display 402 includes a tool bar 406 or the like with a feedback graphical icon 408. A feedback alert 410 may be provided to visually indicate to the user at client station 102 (or supervisor) that audio quality may be improved by a suggestion. The feedback alert 410 may be activated by the user or, alternatively, automatically activated to provide feedback. Thus, instead of the alert 410, the message may pop directly into display 402. However, it is believed using alert 410 will more effectively provide real-time or near real-time feedback to the user or user's supervisor, or a combination thereof, without disrupting operations.

Suggestions may be, for example, relating to operation of the dictation application and equipment. For example, the audio quality manager may review audio files to ensure the audio file has a leading and trailing portion with silence, in other words, no utterances. The leading portion and trailing portion of the audio file should have some time where the system records only silence or noise. While it is envisioned that the amount of silence should be configurable based on the user, in a current configuration, the amount of leading and trailing silence should be about 0.375 seconds. Other possible configurations include requiring up to about 1 second of silence. Other configurations include, for example, 0.375 seconds or less. Still other configurations include between about 0.3 and 0.5 seconds of initial or trailing silence. If the audio file begins or ends without silence or noise, i.e., begins or ends with an utterance, it is possible the user is activating the microphone too close and truncating the beginning and/or ending of the audio. The feedback may be a reminder provided via a text, email, instant message, SMS, or audio notification indicating, for example: “Please press the microphone activation before you start speaking” or “Please complete your statement prior to deactivating the microphone.”

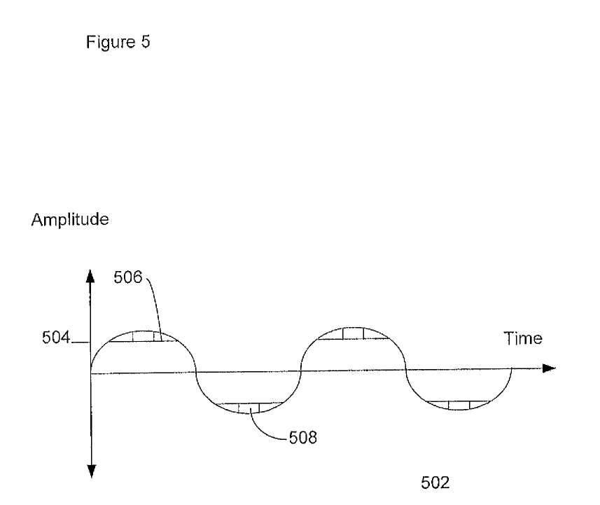

Audio quality manager 200 also may evaluate the signal levels of the audio file. For example, the audio may be “too loud” for the system resulting in clipping the audio as shown in FIG. 5. FIG. 5 shows, for example, a sine waveform 502 that may be exemplary of an audio file (however, audio files would rarely form a sine wave, but the sine wave provides a simple exemplary embodiment of the issue relative to clipping). A typical sine waveform 502 forms a continuous curve. However, audio that saturates or overloads the system reaches a maximum amplitude 504 that the audio system can accommodate. Thus, at maximum amplitude 504, the signal waveform is clipped forming a plateau 506 resulting in the loss of clipped signal 508. Clipping occurs when an amplifier in the system receives an input that it is not capable of amplifying fully due to, for example, power constraints. Clipping the audio file may cause transcription errors. Thus, audio quality manager 200 may provide feedback to the user to, for example, adjust the microphone location to provide more distance between the microphone and the mouth or the user as the input signal amplitude will be decreased with distance, a request that the user modulate his/her voice to a lower volume, etc.

The audio quality manager 200 also may monitor the signal to noise ratio (SNR). Generally, the signal to noise ratio is a comparison of the power of a desired signal to the power of the noise signal. High signal to noise ratios generally mean it is easier to filter the noise from the signal. A low signal to noise ratio may, for example, indicate that the audio is not sufficiently loud, or too quiet for the system to adequately distinguish the signal from the noise. Thus, the audio quality manager 200 may provide feedback to the user to, for example, adjust the microphone location to provide less distance between the microphone and the mouth of the user, to reduce the background noise, etc.

While it may be beneficial to analyze any given audio file, one benefit of the audio quality manager is the ability to store the audio file and monitor a series of files for historical trends. For example, audio quality manager 200 may provide a notification if the user speaks prior to activating the microphone for any given file, but if the user only makes this particular error once in a while, the suggestion may become irritating or, worse, ignored. Thus, audio quality manager 200 may store a violation in a memory, for example, by increasing a counter. If the counter exceeds a threshold, the suggestion or feedback may be provided. Configuration of the feedback could be, for example, increase the counter when the event happens and decrease the counter when the event does not happen. Thus, if on balance the undesired event occurs more often than not, the suggestion/feedback will eventually be provided.

Additionally, the audio quality manager 200 may evaluate trending information. For example, for saturation of the system or clipping, the system may monitor the total percentage of the signal that is being clipped as well as whether the percentage being clipped is increasing. For example, if a total audio signal is 15 seconds, but only 0.5% or less of the signal is clipped, the system and equipment may be considered to be functioning properly. But if the amount of signal being clipped exceeds 0.5%, the suggestion/feedback may be provided. Also, by reviewing trending information, the audio quality manager 200 may determine that over 3 concurrent sessions of clipped audio is above the acceptable limit. In such a trending situation, the system may provide the feedback/suggestion to inhibit the 0.5% signal clip from occurring. A similar trending analysis is performed for signal to noise ratios. While 0.5% signal clip is one possible configuration, the configuration of the amount of signal clip is acceptable may be different for other users. In some situations, up to about 1% or more signal clip may be acceptable.

While the above are examples of several audio statistics that may be monitored, measured, and examined, it is possible to evaluate many types of information relating to the audio file including, for example, audio length, the number of samples, the number of clipped samples, the average root means square, the average sample value, the average noise, the average signal, the peak signal, the signal to noise ratio, the signal length, early speech truncation/late speech truncation/both ends truncated/endpointing, MAC address, sound card, gain levels, and confidence levels. In certain evaluations, feedback regarding system use may be provided. For example, the feedback may be a suggestion regarding reorienting the equipment such as repositioning the microphone, decreasing background noise (if possible), etc. In certain evaluations, for example, gain levels (which may result in excessive clipping or low SNRs), confidence levels, and sound card issues, the feedback or suggestion may be to reinstall all or a portion of the application to facilitate operation and/or re-run sound checks and the like.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

We claim:

1. An apparatus comprising,
a dictation manager coupled to a first network that receives an audio file from a client station, the dictation manager configured to transmit the audio file received from the client station to a dictation server that transcribes the audio file to a textual file;
a memory coupled to the dictation manager, the memory configured to store the audio file received by the dictation manager; and
an audio quality manager coupled to the dictation manager to provide information regarding the quality of the audio in the audio file, the audio quality manager comprising a processor to compare the audio file from the client station to at least one parameter that effects audio quality stored in a memory coupled to the audio quality manager and transmits configuration adjustments to be received, wherein implementation of the configuration adjustments would function to improve the quality of the received audio file, which would improve the quality of the transcription.

2. The apparatus of claim 1 wherein the first and second networks are the same.

3. The apparatus of claim 2 wherein the first and second networks are a bus protocol.

4. The apparatus of claim 1 wherein the first network is selected from a group of networks consisting of: an internet, a lan, a wan, a wlan, a wifi network, a Bluetooth network, a wimax, an Ethernet, cellular network, or a combination thereof.

5. The apparatus of claim 1 wherein the configuration adjustments are transmitted using a short message service, an email, or a voice mail.

6. The apparatus of claim 1 wherein the at least one parameter includes determining whether the audio file has at least a leading period of silence prior to the first utterance, a trailing period of silence subsequent to the last utterance, or a combination thereof.

7. The apparatus of claim 1 wherein the configuration adjustment includes requesting the client to activate or deactivate the recording with sufficient time for the utterance to be received.

8. The apparatus of claim 1 wherein the at least one parameter includes determining whether the audio file is clipped.

9. The apparatus of claim 8 wherein the configuration adjustment includes requesting the client to speak with less amplitude.

10. The apparatus of claim 1 wherein the at least one parameter includes determining whether the signal to noise ratio of the audio file is below a predetermined threshold.

11. The apparatus of claim 10 wherein the configuration adjustment includes requesting that the client adjust the microphone location.

12. A method of evaluating the quality of an audio file received for dictation from a client station comprising the steps performed on at least one processor of:
receiving an audio file from a client station;
comparing the audio file received from the client station to at least one predetermined parameter regarding the quality of the audio file; and
transmitting information to improve a quality of the audio file received from the client station based on the comparison of the audio file to the at least one predetermined parameter.

13. The method of claim 12 wherein receiving the audio file comprises receiving a streamed audio file from a client station.

14. The method of claim 12 wherein the predetermined parameters are selected from a group of parameters relating to audio quality consisting of: leading silence, trailing silence, signal to noise ratio, clipping, or a combination thereof.

15. The method of claim 12 wherein the transmitted information is transmitted to the client station and comprises forming a message in a format from a group of formats consisting of: short message service, voice message, electronic mail, or a combination thereof.

16. The method of claim 15 wherein the transmitted information is transmitted to an administrator.

17. A system comprising:
a client station, the client station comprising a communication device;
a dictation manager coupled to the client station to receive audio from the client station;
a dictation server, the dictation server coupled to at least the dictation manager to receive the audio, the dictation server comprising a speech to text engine to convert the audio to a textual file;
an audio quality manager coupled to the dictation manager; and
at least one memory coupled to the audio quality manager, the memory comprising parameter data usable to determine the quality of the audio received by the dictation manager, wherein the audio received from the client station is comparable to the parameter data and the audio quality manager is configured to provide feedback to improve the quality of the audio.

18. The system of claim 17 wherein the communication device comprises a wireless telephone.

19. The system of claim 17 wherein the feedback causes an alert to be displayed at the client station.

20. The system of claim 18 wherein the wireless telephone is a cellular telephone.
